(19) United States
(12) Patent Application Publication
(10) Pub. No.: US 2026/0088991 A1
(43) Pub. Date: Mar. 26, 2026

(54) DATA SOVEREIGNTY GATEWAY FOR TELEMETRY SIGNALS

(71) Applicant: INTERNATIONAL BUSINESS MACHINES CORPORATION, Armonk, NY (US)

(72) Inventors: Patrick Aaron Tamborski, Chicago, IL (US); Mark Duane Seaborn, Algonquin, IL (US)

(21) Appl. No.: 18/896,004

(22) Filed: Sep. 25, 2024

(51) Int. Cl. H04L 9/08

(52) U.S. Cl. CPC H04L 9/088

(57) ABSTRACT

A method, system, and computer program product are configured to: receive a telemetry message in a telemetry pipeline; determine a classification of the telemetry message; select, based on the classification of the telemetry message, an attribute-based encryption (ABE) ciphertext from plural different ABE ciphertexts, wherein each respective one of the plural different ABE ciphertexts is encoded with a respective data sovereignty policy; attach the ABE ciphertext to the telemetry message; and forward the telemetry message with the ABE ciphertext to a data sovereignty gateway.

### BACKGROUND

Aspects of the present invention relate generally to distributed computing systems and, more specifically, to systems and methods of ensuring data sovereignty in distributed computing systems.

Data sovereignty is the concept that data is subject to the laws of the country or region where it was generated. Data sovereignty is fast becoming a core part of legal, privacy, security and governance strategies for enterprises that deal with the storage, processing and transfer of data. Data sovereignty requirements typically surround the data privacy regulations in a specific country or region. Key concerns for organizations seeking to comply with local laws typically include cybersecurity, data security and privacy, protecting sensitive data from breaches and malware and controlling which individuals, entities and applications can access data. Data sovereignty is determined by the specific laws and regulations that govern the region or country where data was generated. These laws vary from territory to territory, but typically, when a country is said to have “sovereignty over” a piece of data, it means it holds jurisdiction and authority over how that data can be used and who can access it.

### SUMMARY

In a first aspect of the invention, there is a computer-implemented method including: receiving, by a processor set, a telemetry message in a telemetry pipeline; determining, by the processor set, a classification of the telemetry message; selecting, by the processor set, an attribute-based encryption (ABE) ciphertext based on the classification of the telemetry message; attaching, by the processor set, the ABE ciphertext to the telemetry message; and forwarding, by the processor set, the telemetry message with the ABE ciphertext to a data sovereignty gateway.

In another aspect of the invention, there is a computer program product including one or more computer readable storage media having program instructions collectively stored on the one or more computer readable storage media. The program instructions are executable to: receive a telemetry message in a telemetry pipeline; determine a classification of the telemetry message; select, based on the classification of the telemetry message, an attribute-based encryption (ABE) ciphertext from plural different ABE ciphertexts, wherein each respective one of the plural different ABE ciphertexts is encoded with a respective data sovereignty policy; attach the ABE ciphertext to the telemetry message; and forward the telemetry message with the ABE ciphertext to a data sovereignty gateway.

In another aspect of the invention, there is a system including a processor set, one or more computer readable storage media, and program instructions collectively stored on the one or more computer readable storage media. The program instructions are executable to: receive a telemetry message in a telemetry pipeline; determine a classification of the telemetry message; select, based on the classification of the telemetry message, an attribute-based encryption (ABE) ciphertext from plural different ABE ciphertexts stored in the telemetry pipeline and received from an ABE authority external to the telemetry pipeline, wherein each respective one of the plural different ABE ciphertexts is encoded with a respective data sovereignty policy; attach the ABE ciphertext to the telemetry message; and forward the telemetry message with the ABE ciphertext to a data sovereignty gateway.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment in accordance with aspects of the present invention.

FIG. 4 shows a block diagram of an exemplary environment in accordance with aspects of the present invention.

FIG. 5 shows a block diagram of an exemplary environment in accordance with aspects of the present invention.

FIG. 6 shows a flowchart of an exemplary method in accordance with aspects of the present invention.

### DETAILED DESCRIPTION

Aspects of the present invention relate generally to distributed computing systems and, more specifically, to systems and methods of ensuring data sovereignty for telemetry signals in distributed computing systems. Collecting, processing, and analyzing telemetry signals from distributed applications/systems is of great importance to an enterprise to efficiently manage or troubleshoot the system. Enterprises that handle telemetry data that is bound by data sovereignty would benefit from a way to respect all current and future data sovereignty related laws or requirements placed upon the enterprise by itself or a third party. Implementations of the present invention address this need by providing systems and methods that use attribute-based encryption (ABE) to encode policies relating to data sovereignty within/adjacent to the telemetry itself. The inventive systems and methods also introduce new components into a telemetry system, these new components being configured to enforce that data sovereignty policies are satisfied or otherwise make decisions based on these data sovereignty policies.

Telemetry signals (referred to herein as telemetry data), are pieces of information of measurements that can be used for monitoring and troubleshooting the performance of applications and platforms in distributed computing systems. A key part of successful application performance is having observability through access to data. Information technology (IT) professionals use telemetry data to determine the health and performance of applications and platforms. Telemetry data is composed primarily of outputs that are collected from logs, metrics and traces. These are often referred to as the three pillars of observability. Collecting, processing, and analyzing telemetry data from distributed applications and systems has become of great importance. Software of all kinds can be instrumented in such a way that telemetry data is generated about the performance of a flow, operation, function, end-to-end network request, service call, etc.

A telemetry pipeline may comprise a set of services, components, and/or functions that ingest telemetry data, optionally transform the telemetry data, and ultimately send the telemetry data to a telemetry backend (or another pipeline). A telemetry backend may comprise a service or set of services that is responsible for post-processing and viewing received telemetry data. A telemetry backend may be a cloud provider, on-premise solution, or some combination of both. A telemetry backend may be configured to generate backend data including visualizations (e.g., dashboards), reports, and alerts based on the received telemetry data. Typically, this backend data can be introspected by human administrators via a client computing device for general purpose monitoring, observing, and understanding of overall system performance. In some examples, the backend data is passed to an automated tool for automated analysis. For example, automated analysis may include analyzing portions of telemetry data, e.g., using machine learning algorithms, to identify patterns in the data associated with an incident. Identifying such patterns is useful in developing remediation actions (e.g., patches, rules, processes, configurations, etc.) aimed at avoiding future occurrences of the incident. This type of analysis can comprise automated root cause analysis (RCA) that uses machine learning to determine a cause of the incident by analyzing portions of the telemetry data.

Telemetry pipelines and telemetry backends pose a problem for enterprises that must comply with data sovereignty rules and/or regulations. For example, it is common for a telemetry pipeline to be composed of microservices where each segment of the pipeline is a microservice, and where different ones of the microservices are hosted in different jurisdictions. In another example, a telemetry backend is often hosted by a cloud provider, which may have servers that are on the premises of an enterprise, in a hybrid cloud, or a multi-cloud. Additionally, a telemetry backend may utilize microservices that are hosted in different jurisdictions. An enterprise that handles telemetry data that is subject to data sovereignty rules and/or regulations may inadvertently violate such rules and/or regulations when the telemetry data is sent to a microservice in a jurisdiction that is different from the jurisdiction in which the telemetry data was generated.

Implementations of the invention address this problem by encoding policies relating to data sovereignty within or adjacent to the telemetry data itself using attribute-based encryption (ABE). ABE is a particular type of public-key encryption in which a secret cryptographic key of a user and ciphertext are dependent upon attributes of the user, such as, for example, the geographic location where the user works, job title of the user, job roles of the user, resource group the user is a member of, security level of the user, and the like. In attribute-based encryption, the decryption of the ciphertext is possible only if the set of attributes of the user key matches the attributes of the ciphertext. There are two main types of attribute-based encryption techniques: key-policy attribute-based encryption (KP-ABE); and ciphertext-policy attribute-based encryption (CP-ABE). In a system that uses attribute-based encryption for access control, a user can simply pass the user key in one of a number of different methods and then have the resource server use that user key to try to unlock a particular protected resource. If the resource server is able to unlock (e.g., decrypt) the protected resource using that particular user key, then the resource server knows that the user is in possession of a credential that grants access to that particular protected resource.

Implementations of the invention further address the above-noted problem by introducing new components in a telemetry system, where the new components enforce that data sovereignty policies are satisfied or otherwise make decisions based on these policies. Systems and methods according to aspects of the present disclosure have the following advantages: services generating telemetry data do not need to be aware of a data sovereignty policy in memory or in configuration due to the nature of ABE used to encode the policies; a node evaluating data sovereignty policies when handling telemetry data need not be aware of the policy attributes, which is particularly advantageous when the system is horizontally scaled; and implementations of the invention reduce the possibility that data sovereignty policies can be discerned by an attacker since policy information can be self-contained within a single authority which is not required to be online at all times. In this manner, implementations of the invention provide an improvement in the technology of handling telemetry data in distributed computing systems by using ABE to enforce data sovereignty policies in the handling of telemetry data.

In accordance with an aspect of the invention, there is a computer-implemented method, comprising: receiving, by a processor set, a telemetry message in a telemetry pipeline; determining, by the processor set, a classification of the telemetry message; selecting, by the processor set, an attribute-based encryption (ABE) ciphertext based on the classification of the telemetry message; attaching, by the processor set, the ABE ciphertext to the telemetry message; and forwarding, by the processor set, the telemetry message with the ABE ciphertext to a data sovereignty gateway. In this manner, implementations of the invention advantageously provide for enforcing data sovereignty polices for handling telemetry data using ABE and based on classification of telemetry messages.

In embodiments of the method, the ABE ciphertext is selected from plural different ABE ciphertexts. This provides the advantage of being able to handle plural different data sovereignty policies by encrypting different data sovereignty policies in different ABE ciphertexts.

Embodiments of the method may further comprise: receiving the plural different ABE ciphertexts from an ABE authority that is external to the telemetry pipeline; and storing the plural different ABE ciphertexts in the telemetry pipeline. Utilizing a trusted ABE authority provides the advantage that a node in the pipeline need not be aware of the plural different data sovereignty policies.

In embodiments of the method, each respective one of the plural different ABE ciphertexts is encoded with a respective data sovereignty policy. This provides the advantage of being able to handle plural different data sovereignty policies by encrypting different data sovereignty policies in different ABE ciphertexts.

In embodiments of the method, each respective one of the plural different ABE ciphertexts is encoded with a respective data sovereignty policy using ciphertext-policy attribute-based encryption. This provides the advantage of utilizing ciphertexts with the encryption scheme, where the ciphertexts may be provisioned by a trusted ABE authority that is external to the pipeline.

In embodiments of the method, the classification of the telemetry message is determined based on comparing metrics, traces, or logs in the telemetry message to one or more mapping rules. This provides the advantage of the being able to enforce data sovereignty polices that are based on different classifications of different types of telemetry data, which provides for fine-grained control of who can access what types of telemetry data.

In embodiments of the method, the attaching the ABE ciphertext to the telemetry message is performed according to an exported format specification. This provides the advantage of facilitating communication and data handling for the element attaching the ABE ciphertext to the telemetry message and the element receiving the telemetry message with the attached ABE ciphertext.

In embodiments of the method, the ABE ciphertext is attached to the telemetry message as a JavaScript Object Notation key/value pair. This provides the advantage of facilitating communication and data handling, by using a common format, for the element attaching the ABE ciphertext to the telemetry message and the element receiving the telemetry message with the attached ABE ciphertext.

In embodiments of the method, the data sovereignty gateway is configured to: receive the telemetry message with the ABE ciphertext; attempt to decrypt the ABE ciphertext using plural different ABE keys; and based on successfully decrypting the ABE ciphertext using a respective one of the plural different ABE keys, send the telemetry message to a telemetry backend associated with the respective one of the plural different ABE keys. This provides the advantage of enforcing data sovereignty policies when handling telemetry messages by sending a telemetry message only to those backends that have credentials that satisfy the data sovereignty policy associated with the telemetry message.

In embodiments of the method, the decryption is successful for the respective one of the plural different ABE keys based on attributes contained in the respective one of the plural different ABE keys satisfying a data sovereignty policy contained in the ABE ciphertext. This provides the advantage of enforcing plural different data sovereignty policies when handling telemetry messages by sending a telemetry message only to those backends that have credentials that satisfy the data sovereignty policy associated with the telemetry message.

In accordance with an aspect of the invention, there is a computer program product comprising one or more computer readable storage media having program instructions collectively stored on the one or more computer readable storage media, the program instructions executable to: receive a telemetry message in a telemetry pipeline; determine a classification of the telemetry message; select, based on the classification of the telemetry message, an attribute-based encryption (ABE) ciphertext from plural different ABE ciphertexts, wherein each respective one of the plural different ABE ciphertexts is encoded with a respective data sovereignty policy; attach the ABE ciphertext to the telemetry message; and forward the telemetry message with the ABE ciphertext to a data sovereignty gateway. In this manner, implementations of the invention advantageously provide for enforcing data sovereignty polices for handling telemetry data using ABE and based on classification of telemetry messages.

In embodiments of the computer program product, respective ones of the plural different ABE ciphertexts are encoded with the respective data sovereignty policies using ciphertext-policy attribute-based encryption. This provides the advantage of utilizing ciphertexts with the encryption scheme, where the ciphertexts may be provisioned by a trusted ABE authority that is external to the pipeline.

In embodiments of the computer program product, the classification of the telemetry message is determined based on comparing metrics, traces, or logs in the telemetry message to one or more mapping rules. This provides the advantage of the being able to enforce data sovereignty polices that are based on different classifications of different types of telemetry data, which provides for fine-grained control of who can access what types of telemetry data.

In embodiments of the computer program product, the data sovereignty gateway is configured to: receive the telemetry message with the ABE ciphertext; attempt to decrypt the ABE ciphertext using plural different ABE keys; and based on successfully decrypting the ABE ciphertext using a respective one of the plural different ABE keys, send the telemetry message to a telemetry backend associated with the respective one of the plural different ABE keys. This provides the advantage of enforcing data sovereignty policies when handling telemetry messages by sending a telemetry message only to those backends that have credentials that satisfy the data sovereignty policy associated with the telemetry message.

In embodiments of the computer program product, the decryption is successful for the respective one of the plural different ABE keys based on attributes contained in the respective one of the plural different ABE keys satisfying a data sovereignty policy contained in the ABE ciphertext. This provides the advantage of enforcing plural different data sovereignty policies when handling telemetry messages by sending a telemetry message only to those backends that have credentials that satisfy the data sovereignty policy associated with the telemetry message.

In accordance with aspects of the invention, there is a system comprising a processor set, one or more computer readable storage media, and program instructions collectively stored on the one or more computer readable storage media. The program instructions are executable to: receive a telemetry message in a telemetry pipeline; determine a classification of the telemetry message; select, based on the classification of the telemetry message, an attribute-based encryption (ABE) ciphertext from plural different ABE ciphertexts stored in the telemetry pipeline and received from an ABE authority external to the telemetry pipeline, wherein each respective one of the plural different ABE ciphertexts is encoded with a respective data sovereignty policy; attach the ABE ciphertext to the telemetry message; and forward the telemetry message with the ABE ciphertext to a data sovereignty gateway. In this manner, implementations of the invention advantageously provide for enforcing data sovereignty polices for handling telemetry data using ABE and based on classification of telemetry messages.

In embodiments of the system, the respective ones of the plural different ABE ciphertexts are encoded with the respective data sovereignty policies using ciphertext-policy attribute-based encryption. This provides the advantage of utilizing ciphertexts with the encryption scheme, where the ciphertexts may be provisioned by a trusted ABE authority that is external to the pipeline.

In embodiments of the system, the classification of the telemetry message is determined based on comparing metrics, traces, or logs in the telemetry message to one or more mapping rules. This provides the advantage of the being able to enforce data sovereignty polices that are based on different classifications of different types of telemetry data, which provides for fine-grained control of who can access what types of telemetry data.

In embodiments of the system, the data sovereignty gateway is configured to: receive the telemetry message with the ABE ciphertext; attempt to decrypt the ABE ciphertext using plural different ABE keys; and based on successfully decrypting the ABE ciphertext using a respective one of the plural different ABE keys, send the telemetry message to a telemetry backend associated with the respective one of the plural different ABE keys. This provides the advantage of enforcing data sovereignty policies when handling telemetry messages by sending a telemetry message only to those backends that have credentials that satisfy the data sovereignty policy associated with the telemetry message.

In embodiments of the system, the decryption is successful for the respective one of the plural different ABE keys based on attributes contained in the respective one of the plural different ABE keys satisfying a data sovereignty policy contained in the ABE ciphertext. This provides the advantage of enforcing plural different data sovereignty policies when handling telemetry messages by sending a telemetry message only to those backends that have credentials that satisfy the data sovereignty policy associated with the telemetry message.

Implementations of the invention are necessarily rooted in computer technology. For example, the step of decrypting ciphertext attached to a telemetry message is computer-based and cannot be performed in the human mind. In embodiments, computer-based decryption algorithms are used decrypt encrypted ABE ciphertext in real time or near real time (e.g., within a matter of milliseconds or microseconds), and the number and complexity of operations performed by such computer-based decryption algorithms cannot be reasonably be performed in the human mind, or with pen and paper, in real time or near real time.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as telemetry signal data sovereignty code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

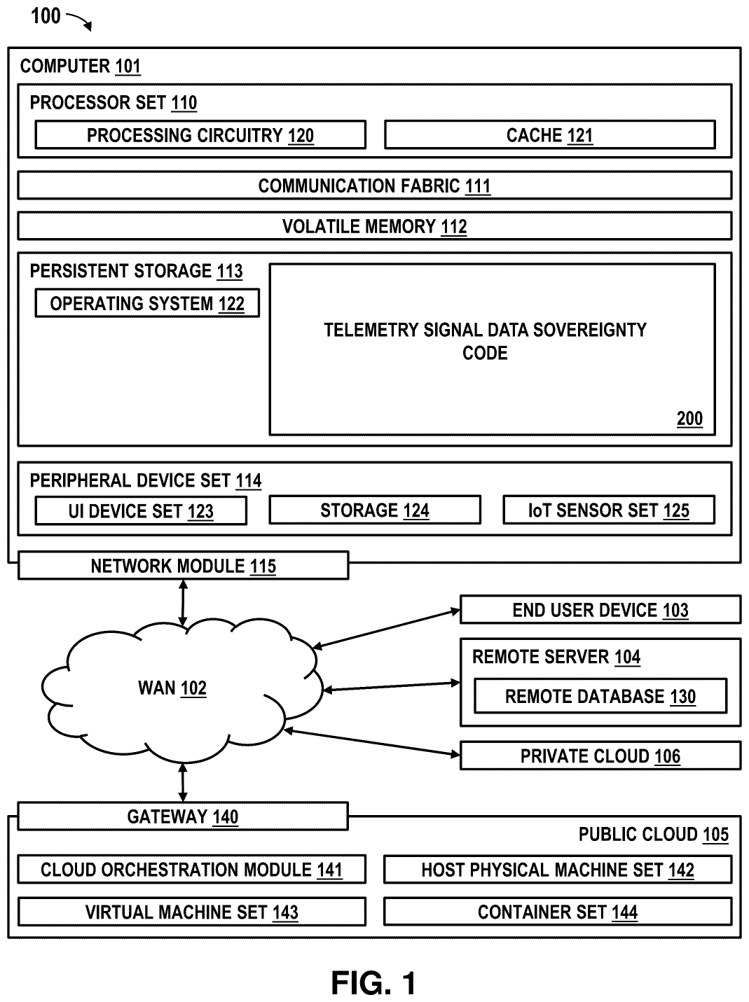

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR (not separately shown in FIG. 1): private and public clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

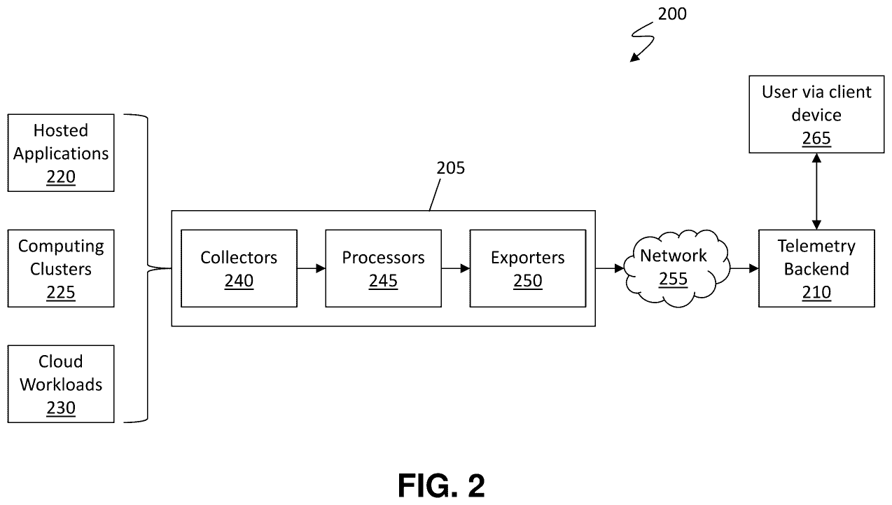

FIG. 2 shows an exemplary telemetry handling environment 200 including a telemetry pipeline 205 and a telemetry backend 210. The telemetry pipeline 205 receives telemetry data from various distributed computing sources including but not limited to hosted applications 220, computing clusters 225, and cloud workloads 230. The telemetry pipeline 205 receives telemetry data via one or more collectors 240. The telemetry pipeline 205 processes the received telemetry data using one or more processors 245, wherein the processing is performed to meet visual, automated, and/or analytical requirements. The telemetry pipeline 205 exports the processed telemetry data using one or more exporters 250 that are configured to send the data to a destination such as the telemetry backend 210 which may be one of plural different telemetry backends. The telemetry pipeline 205 may be implemented as a monolithic application or as a service-oriented architecture. In one example, the one or more collectors 240, the one or more processors 245, and the one or more exporters 250 are implemented as microservices in a service-oriented architecture. The telemetry pipeline 205 may transmit the telemetry data to the telemetry backend 210 via a network 255. The telemetry backend 210 may be configured to generate backend data including visualizations (e.g., dashboards), reports, and alerts based on the received telemetry data. This backend data can be introspected by human user 265, e.g., via a client computing device, for general purpose monitoring, observing, and understanding of overall system performance of the various sources 220, 225, and 230.

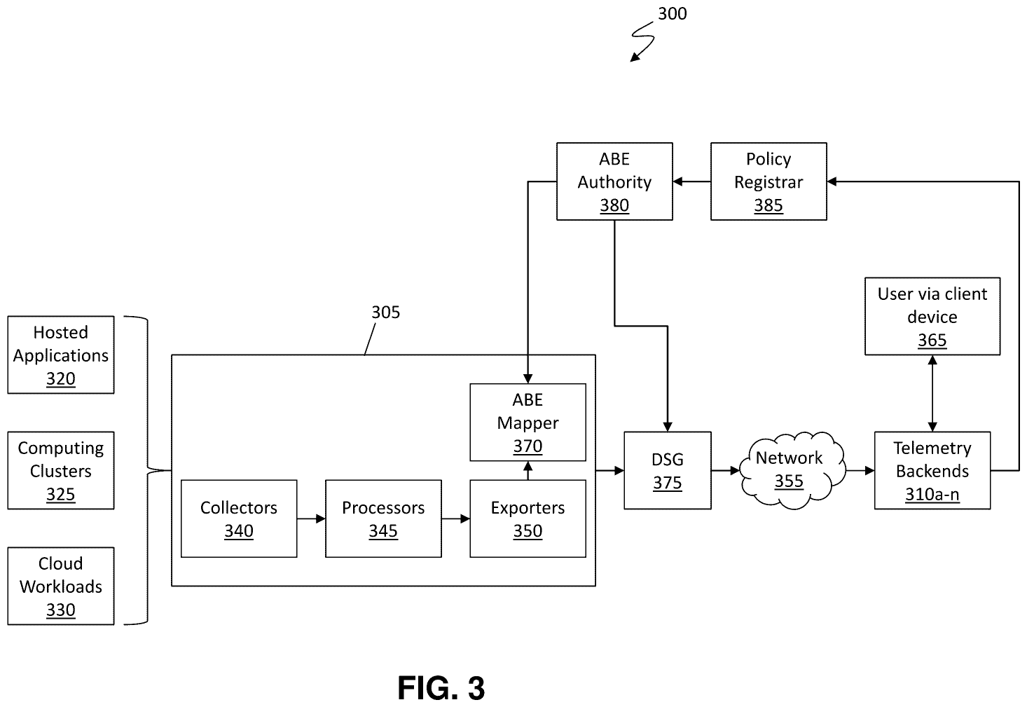

FIG. 3 shows an exemplary telemetry handling environment 300 in accordance with aspects of the present invention. The telemetry handling environment 300 includes a telemetry pipeline 305 that communicates with plural telemetry backends 310a-n via a network 355. There may be any integer number “n” of telemetry backends 310a-n, each comprising a service or set of services running on a computer device and configured to generate backend data as described herein. In embodiments, the telemetry pipeline 305 receives telemetry data from various distributed computing sources including but not limited to hosted applications 320, computing clusters 325, and cloud workloads 330. In various examples, the telemetry data is automatically generated by one or more system monitoring tools that monitor one or more of the sources 320, 325, and 330, and includes at least one of logs, metrics, and traces. Logs are files that record events, warnings, and errors as they occur within a software environment. Metrics are quantifiable measurements that reflect the health and performance of applications or infrastructure. A trace is data that tracks an application request as it flows through the various parts of an application.

In embodiments, the telemetry pipeline 305 includes one or more collectors 340, one or more processors 345, one or more exporters 350, and an ABE mapper 370. The one or more collectors 340 are configured to collect telemetry data from one or more of the sources 320, 325, and 330 and pass the collected telemetry data to the one or more processors 345. The one or more processors 345 are configured to process the telemetry data, for example, by adjusting or modifying the telemetry data to meet visual, automated, and/or analytical requirements. The one or more exporters 350 are configured to receive the processed telemetry data from the one or more processors 345 and provide the processed telemetry data to the ABE mapper 370. In accordance with aspects of the invention, the ABE mapper 370 is configured to attach encrypted metadata to a telemetry message based on a classification of the telemetry message. In various embodiments, the encrypted metadata is in the form of ABE ciphertext that is encoded with one or more data sovereignty policies that apply to the telemetry message to which the encrypted metadata is attached. The telemetry pipeline 305 may be implemented as a monolithic application or as a service-oriented architecture. In one example, the one or more collectors 340, the one or more processors 345, the one or more exporters 350, and the ABE mapper 370 are implemented as microservices in a service-oriented architecture.

With continued reference to FIG. 3, and in accordance with aspects of the present invention, a data sovereignty gateway (DSG) 375 is appended to the downstream edge of the telemetry pipeline 305. In embodiments, the DSG 375 is configured to receive a telemetry message with attached ABE ciphertext from the telemetry pipeline 305, extract the ABE ciphertext from the telemetry message, and attempt to decrypt the ABE ciphertext with one or more ABE keys. In embodiments, each of the ABE keys contains attributes that describe the owner(s) of the key. Decryption is successful for an ABE key if the attributes contained in the ABE key satisfy the policies contained in the ABE ciphertext. In embodiments, in response to decrypting the ABE ciphertext using a respective one of the ABE keys, the DSG 375 transmits the telemetry message to a respective one of the telemetry backends 310a-n that is defined as being associated with the respective one of the ABE keys. The respective one of the telemetry backends 310a-n receiving a telemetry message from the DSG 375 may process the telemetry message in a typical manner, for example by generating backend data including visualizations (e.g., dashboards), reports, or alerts based on the received telemetry message. Such backend data can be introspected by human user 365, e.g., via client computing device, for general purpose monitoring, observing, and understanding of overall system performance of the various sources 320, 325, and 330. In some embodiments, the backend data is passed to an automated tool for automated analysis. In a non-limiting example, automated analysis may include analyzing portions of the telemetry data using machine learning algorithms to identify patterns in the data associated with an incident. Identifying such patterns is useful in developing remediation actions (e.g., patches, rules, processes, configurations, etc.) aimed at avoiding future occurrences of the incident. This type of analysis can comprise automated root cause analysis (RCA) that uses machine learning to determine a cause of the incident by analyzing portions of telemetry data determined using an identified region of interest. This example is not limiting, and other types of automated analysis of the backend data may be performed using artificial intelligence.

In accordance with aspects of the invention, the DSG 375 transmits a particular telemetry message only to respective ones of the telemetry backends 310a-n that are associated with an ABE key that can be used to successfully decrypt the ABE ciphertext attached to the particular telemetry message. In this manner, the inventive systems and methods described herein utilize the ABE ciphertext and the ABE keys to enforce data sovereignty policies for telemetry messages that are handled by the telemetry pipeline 305. This is because each respective ABE key contains attributes that describe an owner of the respective ABE key, and a respective ABE key can only decrypt a respective ABE ciphertext when the attributes in the respective ABE key satisfy the policies contained in the respective ABE ciphertext, such that the DSG 375 will only transmit a respective telemetry message to an owner that has attributes that satisfy the data sovereignty policies for the respective telemetry message (and, conversely, the DSG 375 will not transmit the respective telemetry message to an owner that has attributes that do not satisfy the data sovereignty policies for the respective telemetry message).

In accordance with further aspects of the invention, the telemetry handling environment 300 includes an ABE authority 380 and a policy registrar 385. Each of the ABE authority 380 and the policy registrar 385 may comprise one or more microservices and/or one or more monolithic applications running on the same or different computer devices. In embodiments, the ABE authority 380 creates the ABE ciphertexts that the ABE mapper 370 attaches to the telemetry messages. In various examples, the ABE authority 380 creates the ABE ciphertexts based on registered policies and provides the ABE ciphertexts to the ABE mapper 370 via network communication. In embodiments, the registered policies comprise data sovereignty policies that define rules and classes for routing of telemetry messages.

In various implementations, the ABE authority 380 provisions the ABE keys to the DSG 375 based on information received from the policy registrar 385, which maintains the data sovereignty policies for the different types of telemetry messages. In embodiments, a respective one of the telemetry backends 310a-n registers with the policy registrar 385 by demonstrating to the policy registrar 385 that the respective telemetry backend satisfies the constraints defined in a respective one or more of the data sovereignty policies maintained by the policy registrar 385. Examples of such constraints include but are not limited to encryption policies for storage of telemetry data, Transport Layer Security (TLS) requirements for transport of the telemetry data, and physical location constraints for nodes that store or access the telemetry data. In one example, a respective one of the telemetry backends 310a-n demonstrates compliance with the constraints via documentation. In response to a successful registration, the policy registrar 385 provides information defining a respective data sovereignty policy and attributes of respective one of the telemetry backends 310a-n that satisfy the respective data sovereignty policy to the ABE authority 380, which then uses this information to create an ABE key that is capable of successfully decrypting a respective one of the ABE ciphertexts that is encoded with the respective data sovereignty policy.

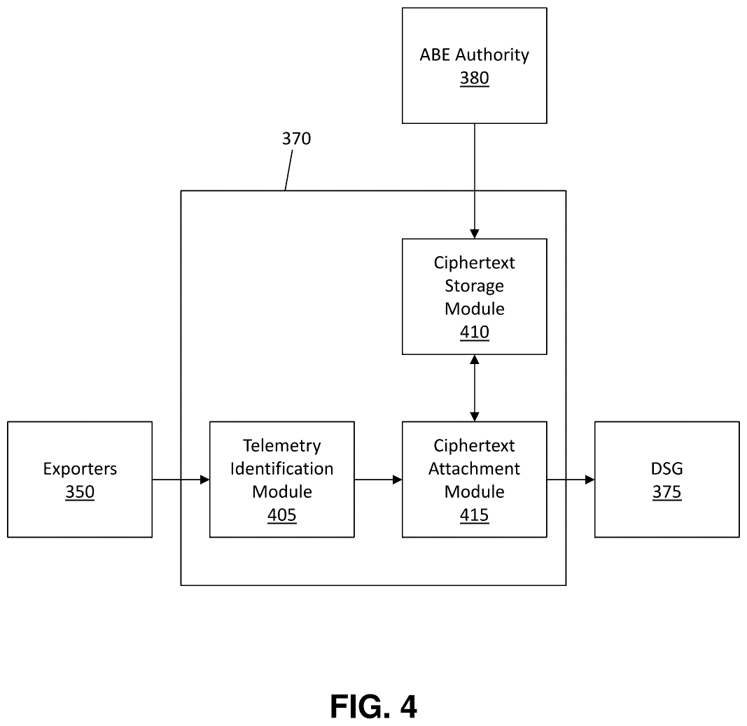

FIG. 4 shows an exemplary diagram of the ABE mapper 370 of FIG. 3 in accordance with aspects of the present invention. In embodiments, the ABE mapper 370 maps an incoming telemetry message to a pre-provisioned ABE ciphertext. In one example, the ABE mapper 370 introspects a telemetry message and determines, based on the introspection, a classification of the telemetry message. The classification may be based on various factors such as, but not limited to, at least one of: type of metric contained in the telemetry message; type of trace contained in the telemetry message; and type of log file contained in the telemetry message. In embodiments, after determining a classification of the telemetry message, the ABE mapper 370 attaches an ABE ciphertext to the telemetry message based on the determined classification of the telemetry message.

In embodiments, and as shown in FIG. 4, the ABE mapper 370 comprises a telemetry identification module 405, a ciphertext storage module 410, and a ciphertext attachment module 415, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The ABE mapper 370 may include additional or fewer modules than those shown in FIG. 4. In embodiments, separate modules may be integrated into a single module. Additionally, or alternatively, a single module may be implemented as multiple modules.

In accordance with aspects of the invention, the telemetry identification module 405 is configured to receive a telemetry message in a telemetry pipeline (e.g., from an exporter 350 of FIG. 3) and classify the telemetry message using one of plural predefined classifications. In embodiments, the telemetry identification module 405 determines a classification of a telemetry message by comparing at least one of the metrics, traces, and logs in the telemetry message to one or more mapping rules. Examples of mapping rules include, but are not limited to: a telemetry message containing a first predefined set of log files is classified with a first classification; a telemetry message containing a second predefined set of log files is classified with a second classification; a telemetry message containing a first predefined class of metrics is classified with a third classification; a telemetry message containing a second predefined class of metrics is classified with a fourth classification; a telemetry message containing a first predefined type of traces is classified with a fifth classification; and a telemetry message containing a second predefined type of traces is classified with a sixth classification. These are nonlimiting examples, and additional and/or different types of classification mapping rules that are based on the metrics, traces, and/or logs may be used.

In accordance with aspects of the invention, the ciphertext storage module 410 is configured to receive plural different ABE ciphertexts from an ABE authority (e.g., ABE authority 380 of FIG. 3) and store these ABE ciphertexts for use by the ciphertext attachment module 415. In embodiments, and as described with respect to FIG. 3, each of the respective ABE ciphertexts is encoded with a respective data sovereignty policy. In one example, a respective one of the ABE ciphertexts has a respective one of the data sovereignty policies encoded within using CP-ABE (ciphertext-policy attribute-based encryption), which is an ABE scheme in which policy information is incorporated into the ciphertext. In this example, the decrypted payload is not meaningful to the ABE mapper 370, and the ABE mapper 370 cannot determine the actual data sovereignty policy using only the ciphertext. In embodiments, each of the ABE ciphertexts is associated with one of the plural predefined classifications. For example, continuing the example described above, the ciphertext storage module 410 may store six different ABE ciphertexts, with respective ones of the six ABE ciphertexts being associated with respective ones of the first through sixth classifications.

In accordance with aspects of the invention, the ciphertext attachment module 415 is configured to receive a telemetry message and a classification of the telemetry message from the telemetry identification module 405, and to attach an ABE ciphertext to the telemetry message based on the classification of the telemetry message. In accordance with aspects of the invention, the ciphertext attachment module 415 obtains one of the ABE ciphertexts from the ciphertext storage module 410 based on the classification of the telemetry message. The ciphertext attachment module 415 then attaches the obtained ABE ciphertext to the telemetry message. In embodiments, the ciphertext attachment module 415 attaches the ABE ciphertext to the telemetry message according to an exported format specification, e.g., as an additional JSON (JavaScript Object Notation) key/value pair. The ciphertext attachment module 415 sends the telemetry message with the attached ABE ciphertext to a DSG, such as DSG 375 of FIG. 3.

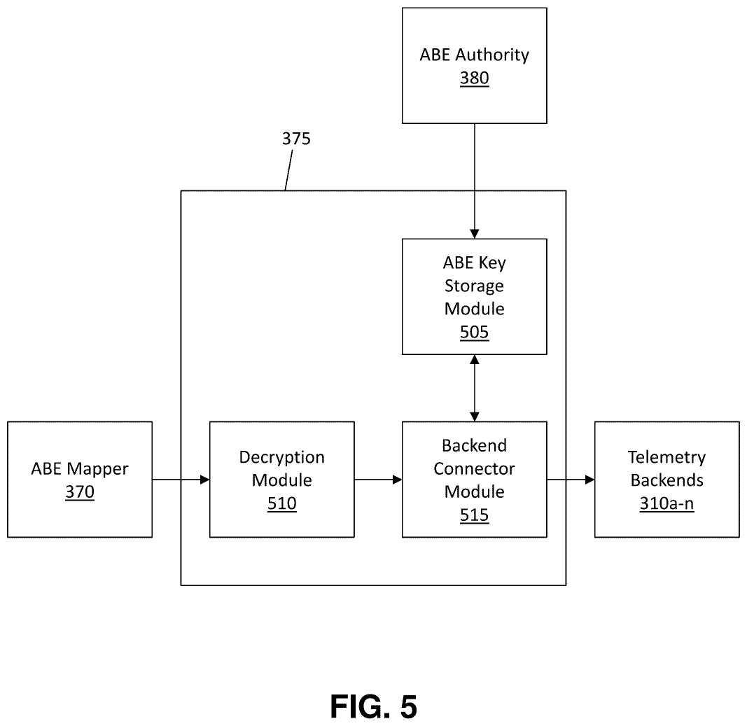

FIG. 5 shows an exemplary diagram of the DSG 375 of FIG. 3 in accordance with aspects of the present invention. In embodiments, the DSG 375 receives a telemetry message with attached ABE ciphertext from the ABE mapper 370, extracts the ABE ciphertext from the telemetry message, and tests the ABE ciphertext against each of one or more ABE keys that have been registered with the DSG 375. If the ABE ciphertext can be successfully decrypted using one of the ABE keys, then the DSG 375 sends the telemetry message to a telemetry backend associated with the one of the ABE keys.

In embodiments, and as shown in FIG. 5, the DSG 375 comprises an ABE key storage module 505, a decryption module 510, and a backend connector module 515, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The DSG 375 may include additional or fewer modules than those shown in FIG. 5. In embodiments, separate modules may be integrated into a single module. Additionally, or alternatively, a single module may be implemented as multiple modules.

In accordance with aspects of the invention, the ABE key storage module 505 is configured to receive plural different ABE keys from an ABE authority (e.g., the ABE authority 380 of FIG. 3) and store these keys for use by the decryption module 510.

In accordance with aspects of the invention, the decryption module 510 is configured to receive a telemetry message with an attached ABE ciphertext, extract the ABE ciphertext from the telemetry message, and determine which, if any, of the ABE keys stored in the ABE key storage module 505 can successfully decrypt the extracted ABE ciphertext. In one example, the decryption module 510 obtains the ABE keys from the ABE key storage module 505 and tests each of these ABE keys against the extracted ABE ciphertext. In embodiments using CP-ABE, and as described with respect to FIG. 3, each respective one of the ABE keys contains attributes that describe an owner of that key, such that a respective one of the ABE keys can be used to decrypt an ABE ciphertext if the attributes included in the respective one of the ABE keys satisfy the policy contained in the ABE ciphertext.

In accordance with aspects of the invention, the backend connector module 515 is configured to receive, from the decryption module 510, a telemetry message and an indication of all the ABE keys that successfully decrypted the ABE ciphertext extracted from the telemetry message. For each respective ABE key that successfully decrypted the ABE ciphertext extracted from the telemetry message, the backend connector module 515 identifies a telemetry backend (e.g., one of telemetry backends 310a-n of FIG. 3) associated with the respective ABE key and transmits the telemetry message to the identified telemetry backend. In embodiments, the backend connector module 515 identifies a telemetry backend associated with an ABE key based on information, received from the ABE authority (e.g., ABE authority 380 of FIG. 3), that defines which ones of the telemetry backends are associated with each of the ABE keys. In embodiments, if none of the ABE keys successfully decrypted the ABE ciphertext extracted from a telemetry message, then the backend connector module 515 drops the telemetry message, e.g., by not transmitting the telemetry message to any of the telemetry backends 310a-n.

In some embodiments, the telemetry handling environment 300 utilizes key-policy attribute-based encryption (KP-ABE) instead of CP-ABE. In embodiments utilizing KP-ABE, the ABE keys are provisioned to the ABE mapper 370. In these embodiments, the ABE mapper 370 is configured to determine an ABE key for a telemetry message in the same manner that the ABE mapper 370 chooses a ciphertext to attach to a telemetry message, e.g., based on a determined classification of the telemetry message. In one example, after the correct key is determined based on an incoming telemetry message, the ABE mapper 370 constructs its own randomized encrypted payload to send to the DSG 375 and attaches this payload to the telemetry message. In another example, the ABE mapper 370 encrypts the telemetry message itself instead of a random string. In both examples, the DSG 375 operates in a similar manner as it does in embodiments that utilize CP-ABE, e.g., by attempting to decrypt the attached ciphertext, or the entire telemetry message itself, using plural different ABE keys.

In some embodiments, there are plural DSGs 375. This may be performed on a per-telemetry-pipeline basis or as required for scaling. In these embodiments, the telemetry pipeline may choose to send the telemetry messages to multiples ones of the plural DSGs 375.

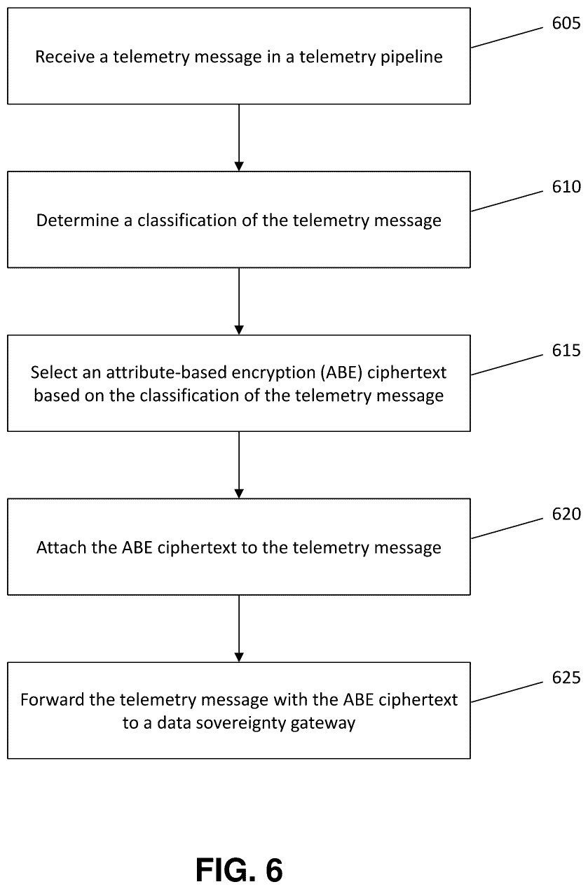

FIG. 6 shows a flowchart of an exemplary method in accordance with aspects of the present invention. Steps of the method may be carried out in the environment of FIG. 3 and are described with reference to elements depicted in FIGS. 3-5.

At step 605, the system receives a telemetry message in a telemetry pipeline. In embodiments, and as described with respect to FIGS. 3-5, the ABE mapper 370 receives a telemetry message from an exporter 350 in the telemetry pipeline 305.

At step 610, the system determines a classification of the telemetry message. In embodiments, and as described with respect to FIGS. 3-5, the ABE mapper 370 determines a classification of the telemetry message that was received at step 605.

At step 615, the system selects an attribute-based encryption (ABE) ciphertext based on the classification of the telemetry message. In embodiments, and as described with respect to FIGS. 3-5, the ABE mapper 370 selects an ABE ciphertext from a plurality of different ABE ciphertexts that have been received from the ABE authority 380, wherein the selecting is performed based on the determined classification of the telemetry message.

At step 620, the system attaches the ABE ciphertext that was selected at 615 to the telemetry message that was received at step 600. In embodiments, and as described with respect to FIGS. 3-5, the ABE mapper 370 attaches the selected ABE ciphertext to the telemetry message.

At step 625, the system forwards the telemetry message with the ABE ciphertext to a data sovereignty gateway. In embodiments, and as described with respect to FIGS. 3-5, the ABE mapper 370 forwards the telemetry message with the attached ABE ciphertext to the DSG 375.

In embodiments, the method includes: receiving the plural different ABE ciphertexts from an ABE authority that is external to the telemetry pipeline; storing the plural different ABE ciphertexts in the telemetry pipeline; and selecting the ABE ciphertext from the plural different ABE ciphertexts stored in the telemetry pipeline.

In embodiments of the method, each respective one of the plural different ABE ciphertexts is encoded with a respective one of plural different data sovereignty policies. In embodiments, the encoding is performed using ciphertext-policy attribute-based encryption.

In embodiments of the method, the classification of the telemetry message is determined based on comparing metrics, traces, or logs in the telemetry message to one or more mapping rules.

In embodiments of the method, the attaching the ABE ciphertext to the telemetry message is performed according to an exported format specification. In one example, the ABE ciphertext is attached to the telemetry message as a JavaScript Object Notation key/value pair.

In embodiments of the method, the data sovereignty gateway is configured to: receive the telemetry message with the ABE ciphertext; attempt to decrypt the ABE ciphertext using plural different ABE keys; and based on successfully decrypting the ABE ciphertext using a respective one of the plural different ABE keys, send the telemetry message to a telemetry backend associated with the respective one of the plural different ABE keys. In embodiments of the method, decryption is successful for the respective one of the plural different ABE keys based on attributes contained in the respective one of the plural different ABE keys satisfying a data sovereignty policy contained in the ABE ciphertext.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a telemetry message in a telemetry pipeline;
determining, by the processor set, a classification of the telemetry message;
selecting, by the processor set, an attribute-based encryption (ABE) ciphertext based on the classification of the telemetry message;
attaching, by the processor set, the ABE ciphertext to the telemetry message; and
forwarding, by the processor set, the telemetry message with the ABE ciphertext to a data sovereignty gateway.

2. The computer-implemented method of claim 1, wherein the ABE ciphertext is selected from plural different ABE ciphertexts.

3. The computer-implemented method of claim 2, further comprising:
receiving the plural different ABE ciphertexts from an ABE authority that is external to the telemetry pipeline; and
storing the plural different ABE ciphertexts in the telemetry pipeline.

4. The computer-implemented method of claim 2, wherein each respective one of the plural different ABE ciphertexts is encoded with a respective data sovereignty policy.

5. The computer-implemented method of claim 2, wherein each respective one of the plural different ABE ciphertexts is encoded with a respective data sovereignty policy using ciphertext-policy attribute-based encryption.

6. The computer-implemented method of claim 1, wherein the classification of the telemetry message is determined based on comparing metrics, traces, or logs in the telemetry message to one or more mapping rules.

7. The computer-implemented method of claim 1, wherein the attaching the ABE ciphertext to the telemetry message is performed according to an exported format specification.

8. The computer-implemented method of claim 1, wherein the ABE ciphertext is attached to the telemetry message as a JavaScript Object Notation key/value pair.

9. The computer-implemented method of claim 1, wherein the data sovereignty gateway is configured to:
receive the telemetry message with the ABE ciphertext;
attempt to decrypt the ABE ciphertext using plural different ABE keys; and
based on successfully decrypting the ABE ciphertext using a respective one of the plural different ABE keys, send the telemetry message to a telemetry backend associated with the respective one of the plural different ABE keys.

10. The computer-implemented method of claim 9, wherein decryption is successful for the respective one of the plural different ABE keys based on attributes contained in the respective one of the plural different ABE keys satisfying a data sovereignty policy contained in the ABE ciphertext.

11. A computer program product comprising one or more computer readable storage media having program instructions collectively stored on the one or more computer readable storage media, the program instructions executable to:
receive a telemetry message in a telemetry pipeline;
determine a classification of the telemetry message;
select, based on the classification of the telemetry message, an attribute-based encryption (ABE) ciphertext from plural different ABE ciphertexts, wherein a respective one of the plural different ABE ciphertexts is encoded with a respective data sovereignty policy;
attach the ABE ciphertext to the telemetry message; and
forward the telemetry message with the ABE ciphertext to a data sovereignty gateway.

12. The computer program product of claim 11, wherein the respective one of the plural different ABE ciphertexts is encoded with the respective data sovereignty policy using ciphertext-policy attribute-based encryption.

13. The computer program product of claim 11, wherein the classification of the telemetry message is determined based on comparing metrics, traces, or logs in the telemetry message to one or more mapping rules.

14. The computer program product of claim 11, wherein the data sovereignty gateway is configured to:
receive the telemetry message with the ABE ciphertext;
attempt to decrypt the ABE ciphertext using plural different ABE keys; and
based on successfully decrypting the ABE ciphertext using a respective one of the plural different ABE keys, send the telemetry message to a telemetry backend associated with the respective one of the plural different ABE keys.

15. The computer program product of claim 14, wherein decryption is successful for the respective one of the plural different ABE keys based on attributes contained in the respective one of the plural different ABE keys satisfying a data sovereignty policy contained in the ABE ciphertext.

16. A system comprising:
a processor set, one or more computer readable storage media, and program instructions collectively stored on the one or more computer readable storage media, the program instructions executable to:
receive a telemetry message in a telemetry pipeline;
determine a classification of the telemetry message;
select, based on the classification of the telemetry message, an attribute-based encryption (ABE) ciphertext from plural different ABE ciphertexts stored in the telemetry pipeline and received from an ABE authority external to the telemetry pipeline, wherein a respective one of the plural different ABE ciphertexts is encoded with a respective data sovereignty policy;
attach the ABE ciphertext to the telemetry message; and
forward the telemetry message with the ABE ciphertext to a data sovereignty gateway.

17. The system of claim 16, wherein the respective one of the plural different ABE ciphertexts is encoded with the respective data sovereignty policy using ciphertext-policy attribute-based encryption.

18. The system of claim 16, wherein the classification of the telemetry message is determined based on comparing metrics, traces, or logs in the telemetry message to one or more mapping rules.

19. The system of claim 16, wherein the data sovereignty gateway is configured to:
receive the telemetry message with the ABE ciphertext;
attempt to decrypt the ABE ciphertext using plural different ABE keys; and
based on successfully decrypting the ABE ciphertext using a respective one of the plural different ABE keys, send the telemetry message to a telemetry backend associated with the respective one of the plural different ABE keys.

20. The system of claim 19, wherein decryption is successful for the respective one of the plural different ABE keys based on attributes contained in the respective one of the plural different ABE keys satisfying a data sovereignty policy contained in the ABE ciphertext.
